(19) United States
(12) Patent Application Publication
(10) Pub. No.: US 2012/0200270 A1
(43) Pub. Date: Aug. 9, 2012

(54) Ultra Low Power Regulator

(75) Inventor: Erik Fossum Faerevaag, Bergen (NO)

(73) Assignee: Energy Micro AS, Oslo (NO)

(21) Appl. No.: 13/501,530

(22) PCT Filed: Oct. 14, 2010
(86) PCT No.: PCT/IB2010/002853

§ 371 Date: Apr. 12, 2012

Related U.S. Application Data
(60) Provisional application No. 61/253,292, filed on Oct. 20, 2009.

(51) Int. Cl. G05F 1/10

(52) U.S. Cl. 323/234

(57) ABSTRACT

A power regulator with minimized power consumption is disclosed. The power regulator includes at least one multiplier module and at least one amplifier module. The multiplier module is configured to multiply the reference voltage to provide a second voltage, while the amplifier module is configured to receive the second voltage and provide a regulated voltage. The magnitude of the second voltage is greater than the magnitude of the reference voltage by a factor greater than one.

### CROSS-REFERENCE TO RELATED APPLICATION

This application claims priority to U.S. Provisional Application Ser. No. 61/253,292, filed on Oct. 20, 2009.

### BACKGROUND

1. Technical Field

The present disclosure relates to power regulation techniques, and more particularly, to devices and methods for providing regulated voltage with minimized power consumption and low supply voltages.

2. Description of the Related Art

Voltage regulators with normal analog regulation schemes are commonly used in the electrical art for a variety of applications. More specifically, regulators are configured to receive a reference voltage and to provide an absolute value of the regulated output voltage. The reference voltage is typically compared to a voltage which is a ratio of the regulated voltage, and if the ratio of the regulated voltage is greater than the absolute value of the reference voltage, the regulator turns off output current to allow the regulated voltage to decrease. Alternatively, if the ratio of the regulated voltage is less than the absolute value of the reference voltage, the regulator turns on output current to allow the regulated voltage to increase.

While such configurations may provide adequate regulation of power, there is still room for improvement. For instance, the network of such a feedback system is resistive, meaning that current must flow constantly from the regulated supply voltage to ground. This further translates into a considerable amount of current, and thus, power that is consumed during operation of the regulator. In other words, a substantial decrease in the amount of electrical current or power that is consumed while operating a typical voltage regulator, a device that is present in essentially all electronic devices, may provide longer device runtimes and significant energy conservation.

In other regulators, an amplifier having a feedback may be used to output a regulated voltage from a reference voltage that is at the same level as the regulated voltage. Such a unity gain feedback does not need a resistive feedback, and thus, does not dissipate power. However, in order to provide a reference voltage that is at the same level as the regulated voltage does typically consume power. More specifically, using a current mirror and a resistor to provide the reference voltage consumes current, and further, places the current mirror in an unfavorable saturated state when the supply voltage is too low. Such saturation may exhibit significant errors in the regulated supply voltage.

Accordingly, there is a need for improved devices and methods which essentially eliminates resistance in the feedback network of a regulation system, significantly reduces the power consumed and minimizes errors associated with saturation without adversely affecting performance.

### SUMMARY OF THE DISCLOSURE

In satisfaction of the aforenoted needs, an apparatus and a method for regulating power using minimal power are disclosed.

In one aspect of the present disclosure, a power regulator with minimized power consumption is disclosed. The power regulator includes at least one multiplier module and at least one amplifier module. The multiplier module is configured to multiply a reference voltage to provide a second voltage, while the amplifier module is configured to receive the second voltage and provide a regulated voltage.

In a refinement, the power regulator further includes at least one switch element configured to selectively sample the reference voltage and provide a sampled reference voltage to the multiplier module.

In a related refinement, the switch element is configured to sample and hold the reference voltage.

In another refinement, the power regulator further includes at least one of a resistive element and a capacitive element at an input thereof.

In another refinement, the power regulator further includes at least one reference module configured to at least partially generate the reference voltage across at least one of a resistive element and a capacitive element.

In another refinement, the power regulator further includes a reference module that is configured as a current source.

In another refinement, the power regulator further includes a reference module that is configured as a voltage source.

In another refinement, the power regulator further includes a reference module that is configured to provide a sampled reference voltage.

In another refinement, the multiplier module includes a voltage doubler configured to generate a second voltage having double the magnitude of the reference voltage.

In another refinement, the multiplier module is configured to increase a magnitude of the reference voltage by a factor greater than one.

In yet another refinement, the amplifier module includes a unity gain amplifier.

In a related refinement, the second voltage is input to a positive input of the unity gain amplifier and the regulated voltage is fed back into a negative input of the unity gain amplifier.

In another aspect of the present disclosure, a method of regulating power with minimized power consumption is disclosed. The method provides a reference voltage, multiplies the reference voltage by a predefined factor so as to provide a second voltage, and regulates the second voltage to provide a regulated voltage.

In a refinement, a magnitude of the second voltage is greater than a magnitude of the reference voltage by a factor greater than one.

In another refinement, the reference voltage is sampled.

In another refinement, the reference voltage is sampled and temporarily held.

In another refinement, the reference voltage is provided across at least one of a resistive element and a capacitive element.

In yet another refinement, the second voltage is regulated using a unity gain amplifier configured to down-regulate the second voltage so as to provide a regulated voltage that substantially matches a magnitude of the reference voltage.

Other advantages and features will be apparent from the following detailed description when read in conjunction with the attached drawings.

### BRIEF DESCRIPTION OF THE DRAWINGS

The ultra low power regulator apparatus and methods are described more or less diagrammatically in the accompanying drawings wherein:

FIG. 1 is a schematic of an exemplary ultra low power regulator device that is constructed in accordance with this disclosure; and

FIG. 2 is a flow diagram of an exemplary method of regulating power with reduced power consumption.

It should be understood that the drawings are not necessarily to scale and that the embodiments are sometimes illustrated by graphic symbols, phantom lines, diagrammatic representations and fragmentary views. In certain instances, details which are not necessary for an understanding of this disclosure or which render other details difficult to perceive may have been omitted. It should be understood, of course, that this disclosure is not limited to the particular embodiments and methods illustrated herein.

### DETAILED DESCRIPTION OF THE DISCLOSURE

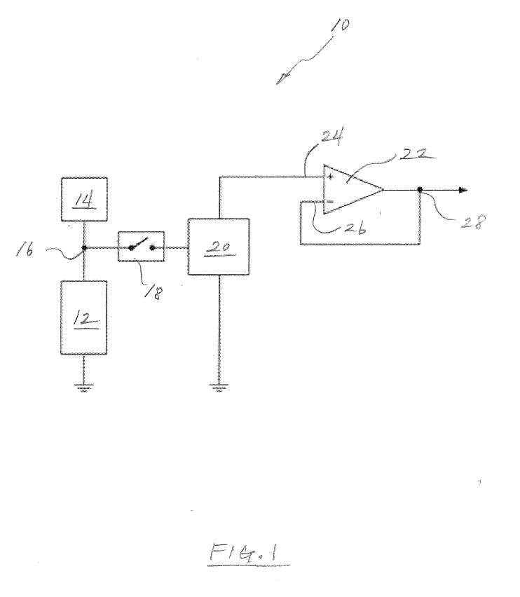

FIG. 1 illustrates an exemplary power regulator 10 constructed in accordance with the teachings of the present disclosure. The disclosed power regulator 10 may be provided with one or more circuit elements 12 electrically coupled to a reference module 14 to form an input node 16 therebetween. For example, the reference module 14 may include a voltage supply or current source configured to at least partially induce an electric current through the circuit element 12 or cause a potential difference or voltage across the circuit element 12. The circuit element 12 may be an active or passive element which includes at least one of a resistive element, a capacitive element, or the like, and further, may be sized to provide the appropriate reference voltage at the input node 16. The power regulator 10 may also be provided with a reference module 14 configured as a capacitively buffered power source, or the like.

In order to minimize the power consumed during power regulation, the regulator 10 may also be provided with a switch element 18 configured to periodically sample rather than continuously source the reference voltage. Specifically, the switch element 18 may be configured to selectively couple the input node 16 to a multiplier module 20 so as to enable sampling of the reference voltage at a predetermined frequency. The switch element 18 may further be configured to sample and hold the sampled reference voltage for further processing. When it is engaged, the switch element 18 may direct the sampled reference voltage from the input node 16 to the multiplier module 20. In alternative embodiments, the switch element 18 may be integrated into the reference module 14 so as to directly provide the multiplier module 20 with a sampled reference voltage.

The multiplier module 20 may multiply the reference voltage by a predefined factor and transmit a second voltage with a greater magnitude to an amplifier module 22, as shown in FIG. 1. More specifically, the multiplier module 20 may include a voltage multiplier that is configured to increase the magnitude of the reference voltage by a factor greater than one. In one embodiment, for example, the multiplier module 20 may include a voltage doubler configured to generate a second voltage that is twice the magnitude of the reference voltage. In alternative embodiments, the multiplier module 20 may similarly generate a second voltage having a magnitude that is, for example, a multiple of 2″ of the magnitude of the reference voltage, wherein n=1, 2, 3 and so on.

In order to further minimize the amount of current that is consumed, the amplifier module 22 may include a buffer, a unity gain amplifier, or the like, as shown for example in FIG. 1. Moreover, a positive input 24 of the amplifier module 22 may be supplied with the second voltage generated by the multiplier module 20 while a negative input 26 of the amplifier module 22 may be provided with a feedback loop. Specifically, the output of the amplifier module 22, or output node 28 of the regulator 10 carrying the regulated voltage, may be fed back into the negative input 26 of the amplifier module 22 so as to enable fast and optimum voltage correction. Furthermore, as the second voltage, or multiplied reference voltage, is ensured to be greater in magnitude than the reference voltage, the amplifier module 22 may be enabled to operate in a purely down-regulating mode of operation so as to require even less current.

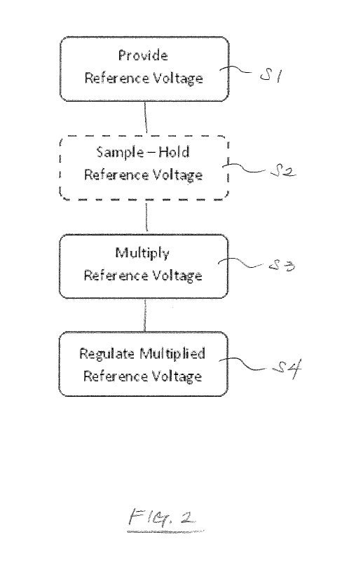

Turning now to FIG. 2, a flow diagram of an exemplary method of regulating power is provided. As an initial step S1, the method may provide a reference voltage to be regulated, for instance, using one or more reference generator modules 14, circuit elements 12, a capacitively buffered power supply, or the like. In reading the reference voltage, the method may include an optional step S2 of sampling and holding the reference voltage at a predefined frequency using, for instance, a switch element 18, or the like, in order to reduce current draw. Alternatively, the reference voltage provided in step S1 may already be a sampled reference voltage, in which case a sample and holding step S2 may be omitted. The method may further multiply the reference voltage by a predefined factor in a step S3 as shown. For instance, the reference voltage may be doubled in magnitude using, for example, a voltage doubling multiplier module 20, to generate a second voltage. In alternative embodiments, the magnitude of the reference voltage may be increased by any other factor greater than one. The multiplied reference voltage, or second voltage, may then be regulated in a step S4. Moreover, the second voltage may be regulated using, for example, a unity gain configuration of an amplifier module 22, so as to limit the amplifier module 22 to down-regulating modes of operation and conserve even more current.

### INDUSTRIAL APPLICABILITY

In satisfaction of the above-identified needs, improved devices and methods are disclosed for providing quicker and more efficient regulation of voltage with minimal power draw from the attached load. More specifically, the disclosed devices and methods employ a voltage multiplication and feedback regulation scheme which collectively serve to minimize the power consumed during operation thereof. A sample and holding scheme can also be applied to the disclosed devices and methods to further reduce current draw. The disclosed devices and methods additionally overcome the need for a current mirror, and thus, eliminate saturation effects and the substantial regulation errors that are associated therewith.

While only certain embodiments have been set forth, alternatives and modifications will be apparent from the above description to those skilled in the art. These and other alternatives are considered equivalents and within the spirit and scope of this disclosure and the appended claims.

What is claimed:

1. A power regulator with minimized power consumption, comprising:
at least one multiplier module configured to receive a reference voltage and multiply the reference voltage to provide a second voltage; and
at least one amplifier module configured to receive the second voltage and provide a regulated voltage.

2. The power regulator of claim 1 further comprising at least one switch element configured to selectively sample the reference voltage and provide a sampled reference voltage to the multiplier module.

3. The power regulator of claim 2, wherein the switch element is configured to sample and hold the reference voltage.

4. The power regulator of claim 1 further comprising at least one of a resistive element and a capacitive element at an input thereof.

5. The power regulator of claim 1 further comprising at least one reference module configured to at least partially generate the reference voltage across at least one of a resistive element and a capacitive element.

6. The power regulator of claim 1 further comprising a reference module that is configured as a current source.

7. The power regulator of claim 1 further comprising a reference module that is configured as a voltage source.

8. The power regulator of claim 1 further comprising a reference module that is configured to provide a sampled reference voltage.

9. The power regulator of claim 1, wherein the multiplier module includes a voltage doubler, the second voltage being double a magnitude of the reference voltage.

10. The power regulator of claim 1, wherein the multiplier module is configured to increase a magnitude of the reference voltage by a factor greater than one.

11. The power regulator of claim 1, wherein the amplifier module includes a unity gain amplifier.

12. The power regulator of claim 11, wherein the second voltage is input to a positive input of the unity gain amplifier and the regulated voltage is fed back into a negative input of the unity gain amplifier.

13. A method of regulating power with minimized power consumption, comprising the steps of:
providing a reference voltage;
multiplying the reference voltage by a predefined factor so as to provide a second voltage; and
regulating the second voltage to provide a regulated voltage.

14. The method of claim 13, wherein a magnitude of the second voltage is greater than a magnitude of the reference voltage by a factor greater than one.

15. The method of claim 13, wherein the reference voltage is sampled.

16. The method of claim 13, wherein the reference voltage is sampled and temporarily held.

17. The method of claim 13, wherein the reference voltage is provided across at least one of a resistive element and a capacitive element.

18. The method of claim 13, wherein the second voltage is regulated using a unity gain amplifier configured to down-regulate the second voltage so as to provide a regulated voltage that substantially matches a magnitude of the reference voltage.
